(19) United States
(12) Patent Application Publication
(10) Pub. No.: US 2026/0274371 A1
(43) Pub. Date: Sep. 17, 2026

(54) FOLDING VEHICLE CAPABLE OF AUTOMATICALLY INTERRUPTING FOLDING SIGNAL

(71) Applicant: Guangdong Prestige Technology Company Limited, Dongguan, Guangdong (CN)

(72) Inventor: Zhao Zhang, Dongguan, Guangdong (CN)

(21) Appl. No.: 19/472,700

(22) PCT Filed: May 24, 2024
(86) PCT No.: PCT/CN2024/095112

§ 371 Date: Oct. 5, 2025

(30) Foreign Application Priority Data
Apr. 28, 2023 (CN) 202321019027.6

(51) Int. Cl. B62K 15/00

(52) U.S. Cl. CPC B62K 15/008

(57) ABSTRACT

A folding vehicle capable of automatically interrupting a folding signal comprises a vehicle frame, a seat base, a sensing device, a drive device and a controller, wherein the seat base is arranged on the vehicle frame and has one end movably arranged on the vehicle frame; the drive device is arranged on the vehicle frame and is electrically connected to the controller to drive the vehicle frame to unfold or fold; and the sensing device is arranged between one end of the seat base and the vehicle frame and is electrically connected to the controller. The seat base triggers the sensing device when same approaches the vehicle frame under the load of gravity, so as to interrupt a signal for controlling the action of the drive device. The structure can prevent the folding vehicle from accidentally folding, thereby improving the riding safety.

### FIELD OF THE INVENTION

The present invention relates to a folding vehicle, and more particularly to a folding vehicle capable of automatically interrupting a folding signal.

### BACKGROUND OF THE INVENTION

Existing foldable mobility scooters are generally foldable to improve the convenience of use. The automatic folding or unfolding of the frame is achieved by controlling the extension and retraction of an electric push rod via a control switch. However, this manner of controlling the automatic folding or unfolding of the frame through a control switch can easily lead to accidental folding of the vehicle during use due to accidental activation of the switch, thereby causing harm to the user, thus the safety of use is not enough.

### SUMMARY OF THE INVENTION

The objective of the present invention is to provide a folding vehicle capable of automatically interrupting a folding signal, which can prevent the vehicle from accidentally folding due to accidental activation of the folding switch while the user is seated, thereby improving the riding safety.

In order to achieve the above objective, the present invention provides a folding vehicle capable of automatically interrupting a folding signal, including a vehicle frame, a seat base, a sensing device, a drive device, and a controller. The seat base is arranged on the vehicle frame and has one end movably connected to the vehicle frame, the drive device is arranged on the vehicle frame and electrically connected to the controller to drive the vehicle frame to unfold or fold, and the sensing device is arranged between one end of the seat base and the vehicle frame and electrically connected to the controller. When bearing a load, the seat base moves close to the vehicle frame and triggers the sensing device, and the controller interrupts a signal controlling an operation of the drive device.

Compared to the prior art, the seat base of the present invention is movably arranged on the vehicle frame, and the sensing device electrically connected to the controller is arranged between the seat base and the vehicle frame. Therefore, when a user sits on the seat base, the seat base moves relative to the vehicle frame to drive and trigger the sensing device, thus the triggered signal is then transmitted to the controller, which controls the drive device to stop operating. By this token, the folding signal of the folding vehicle can be automatically interrupted by the sensing device, which prevents the vehicle with a user loaded thereon from accidentally folding due to misuse of the control switch, thereby avoiding accidental harm to the user caused by unexpected folding. The interruption is automatically triggered by the weight of the user sitting thereon, without requiring manual intervention, thereby enabling automatic control and effectively improving the safety of the folding vehicle.

Preferably, an elastic member is arranged between the vehicle frame and the seat base, and the elastic member provides an elastic force to move the seat base away from the vehicle frame, thereby releasing a triggered state of the sensing device. By providing the elastic member, the seat base can automatically reset, causing the sensing device to release the trigger when no one is seated. This allows the controller to send a drive signal to activate the drive device, thereby achieving the folding of the vehicle frame.

Preferably, one end of the vehicle frame is pivotally connected to a rear end of the seat base, and another end of the vehicle frame is provided with a slot; a front end of the seat base is slidably arranged in the slot via a sliding shaft, when the seat base bears a load, the sliding shaft slides from one end of the slot toward the other end in a direction closer to the vehicle frame. By providing the slot, the seat base can move relative to the vehicle frame without disengaging from it, thereby providing the force for triggering or releasing the sensing device and achieving the purpose of automatic control.

Specifically, the sensing device includes a sensor and a first triggering member, the sensor is arranged on the vehicle frame and electrically connected to the controller, the first triggering member is connected to the front end of the seat base to move closer to the sensor and trigger the sensor as the seat base moves. By positioning the sensor on the vehicle frame and using the first triggering member to follow the movement of the seat base, the first triggering member can trigger or release the trigger of the sensor.

Specifically, the sensor is fixed inside a first support rod of the vehicle frame, the first triggering member is slidably arranged on the first support rod of the vehicle frame, the first triggering member is provided with an elongated hole, and the sliding shaft slidably passes through the elongated hole. By providing the elongated hole and slidably arranging the sliding shaft within it, the first triggering member can both follow the movement of the seat base and move linearly along the direction of the first support rod. This makes the movement of the first triggering member more stable, thereby facilitating reliable contact with the sensor.

Specifically, the sensing device further includes a second triggering member fixed inside the first support rod of the vehicle frame, and the sensor is fixed on the second triggering member.

Specifically, the vehicle frame includes a first support rod, a second support rod, and a third support rod. The first support rod and the second support rod are arranged in a crossed manner and pivotally connected to each other at middle parts thereof. The upper end of the second support rod is pivotally connected to the lower end of the third support rod. The upper end of the third support rod is pivotally connected to the rear end of the seat base. The slot is provided at the upper end of the first support rod.

Specifically, the slot has an arc-shaped structure.

Specifically, the slot has a bent structure.

Specifically, the slot includes a first slot and a second slot, the first slot extends from an upper end toward a front lower direction of the folding vehicle and communicates with one end of the second slot, and the second slot extends toward a rear lower direction of the folding vehicle. By configuring the slot as a bent structure, during the folding process, the sliding shaft can slide into the first slot and use the sidewall of the first slot to prevent movement in other directions, thereby achieving self-locking. This avoids the seat base being pressed down due to external forces during folding, which would trigger the sensing device, thus improving the operational reliability.

### BRIEF DESCRIPTION OF THE DRAWINGS

FIG. 1 is a perspective view of the folding vehicle capable of automatically interrupting a folding signal according to the present invention.

FIG. 2 is a side view of the folding vehicle according to the present invention.

FIG. 3 is an exploded view of the seat base and frame of the folding vehicle according to the present invention.

FIG. 4 is a state diagram of the sensing device when the folding vehicle according to the present invention bears no load.

FIG. 5 is a state diagram of the sensing device when the folding vehicle according to the present invention bears a load.

FIG. 6 is a state diagram of the sliding shaft within the slot after the folding vehicle according to the present invention is folded.

FIG. 7 is a state diagram of the folding vehicle according to the present invention after folding.

### DETAILED DESCRIPTION OF ILLUSTRATED EMBODIMENTS

To elaborate the technical content, structural features, and achieved effects of the present invention, the following description is provided in conjunction with the embodiments and the drawings for a detailed explanation.

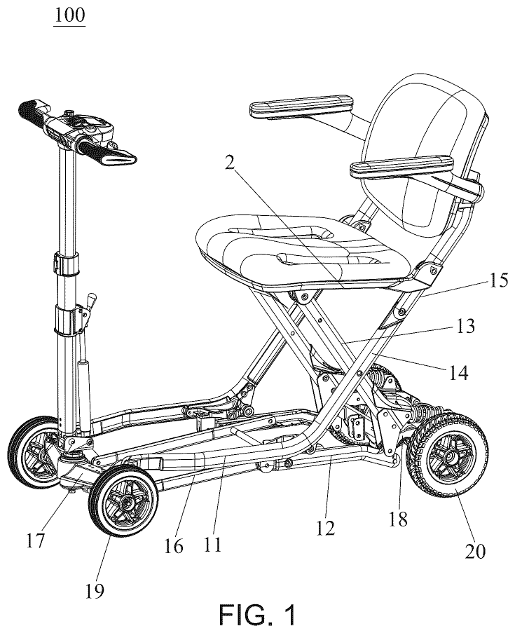

As shown in FIGS. 1 to 4, the folding vehicle 100 capable of automatically interrupting a folding signal according to the present invention includes a vehicle frame 1, a seat base 2, a sensing device 3, a drive device 4, and a controller 5. The seat base 2 is arranged on the vehicle frame 1 and has one end movably connected to the vehicle frame 1. Specifically, the rear end of the seat base 2 is pivotally connected to one end of the vehicle frame 1, allowing the seat base 2 to swing a certain angle relative to the vehicle frame 1. The front end of the seat base 2 is connected to the other end of the vehicle frame 1 and can move closer to or away from this end of the vehicle frame 1. The drive device 4 is arranged on the vehicle frame 1 and electrically connected to the controller 5 to drive the vehicle frame 1 to unfold or fold. The drive device 4 is a linear actuator, such as an electric push rod. The sensing device 3 is arranged between one end of the seat base 2 and the vehicle frame 1 and electrically connected to the controller 5. When bearing a load, the seat base 2 moves close to the vehicle frame 1 and then triggers the sensing device 3, so that the controller 5 interrupts a signal controlling an operation of the drive device 4.

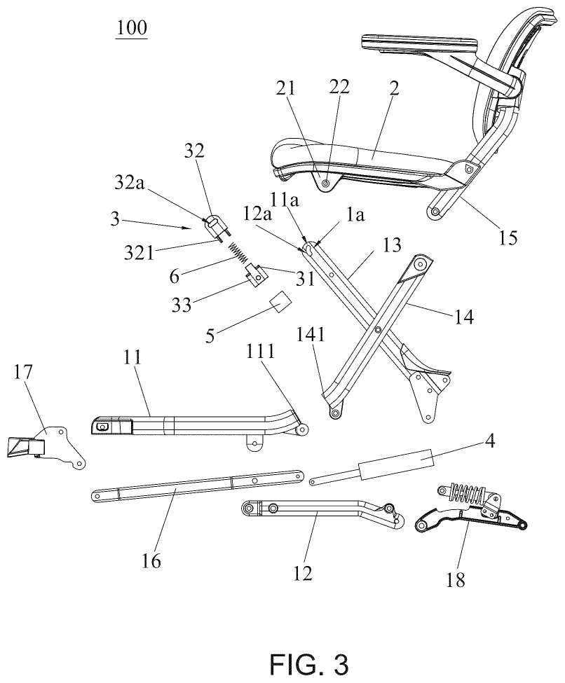

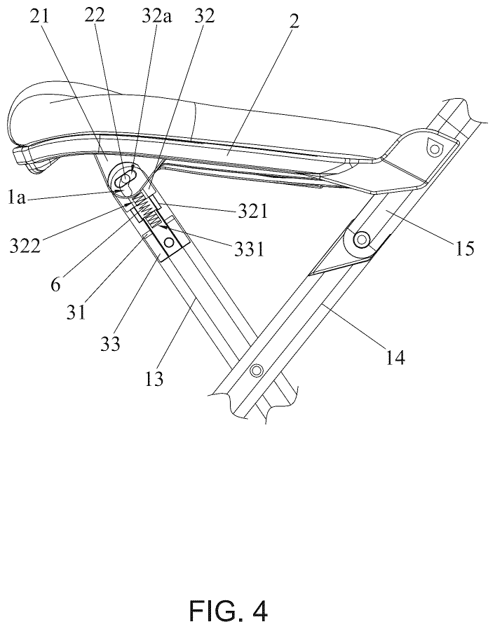

Referring to FIGS. 3 and 4, an elastic member 6 is arranged between the vehicle frame 1 and the seat base 2. The elastic member 6 provides an elastic force to move the seat base 2 away from the vehicle frame 1. When the seat base 2 is under no load, the elastic force of the elastic member 6 is sufficient to push the seat base 2 away from the vehicle frame 1, thereby releasing the triggered state of the sensing device 3. The elastic member 6 is a compression spring. By providing the elastic member 6, the seat base 2 can be automatically reset, causing the sensing device 3 to release the trigger when no one is seated, so that the controller 5 sends a drive signal to activate the drive device 4, thereby achieving the folding of the vehicle frame 1.

Referring to FIGS. 3 to 5, the end of the vehicle frame 1 proximate to the front end of the seat base 2 is provided with a slot la. The lower side of the front end of the seat base 2 is provided with a connecting lug 21. The connecting lug 21 is provided with a transverse sliding shaft 22. The sliding shaft 22 is slidably arranged within the slot 1a, so that when the seat base 2 bears a load, the sliding shaft 22 slides from one end of the slot 1a to the other end in a direction closer to the vehicle frame 1. By providing the slot 1a, the seat base 2 can move relative to the vehicle frame 1 without disengaging from it, thereby providing the force for triggering or releasing the sensing device 3 and achieving the automatic control. In this embodiment, the slot 1a is bent. Specifically, the slot 1a includes a first slot 11a and a second slot 12a. The first slot 11a extends from the upper end toward the front lower direction of the folding vehicle 100 and communicates with one end of the second slot 12a. The second slot 12a extends toward the rear lower direction of the folding vehicle 100. The width of the first slot 11a and the second slot 12a is greater than the diameter of the sliding shaft 22, thereby allowing the sliding shaft 22 to be arranged within the first slot 11a or the second slot 12a with clearance. By configuring the slot 1a as a bent structure, during the folding, the sliding shaft 22 can slide into the first slot 11a and meanwhile prevent the movement in other directions with the help of the sidewall of the first slot 11a, thereby achieving self-locking. In such way, it avoids the seat base 2 being pressed down due to external forces during the folding, which would trigger the sensing device 3, thus improving the operational reliability. Additionally, in other embodiments, the slot 1a may have an arc-shaped structure.

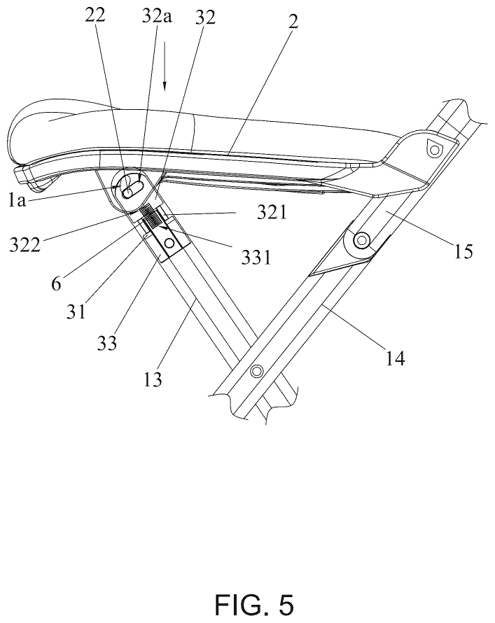

Referring to FIGS. 4 and 5, the sensing device 3 includes a sensor 31, a first triggering member 32, and a second triggering member 33. The sensor 31 is arranged on the vehicle frame 1 and electrically connected to the controller 5. The first triggering member 32 is connected to the lower side of the front end of the seat base 2 to move closer to the sensor 31 and trigger the sensor 31, or move away from the sensor 31 and release the trigger, as the seat base 2 moves. Since the sensor 31 is arranged on the vehicle frame 1, and the first triggering member 32 follows the movement of the seat base 2, thus the first triggering member 32 can trigger or release the trigger of the sensor 31. Specifically, the second triggering member 33 is fixed inside the first support rod 13. The sensor 31 is fixed on the second triggering member 33, thereby being fixed inside the first support rod 13. More specifically, the first triggering member 32 is slidably arranged inside the first support rod 13 of the vehicle frame 1. The first triggering member 32 is provided with an elongated hole 32a, with the extending direction of the elongated hole 32a being perpendicular to the length direction of the first support rod 13. The sliding shaft 22 slidably passes through the elongated hole 32a. By arranging the sliding shaft 22 within the elongated hole 32a slidably, the first triggering member 32 can both follow the movement of the seat base 2 and move linearly along the direction of the first support rod 13, which makes the movement of the first triggering member 32 more stable, thereby facilitating reliable contact with the sensor 31. The side of the first triggering member 32 facing the sensor 31 is provided with a support leg 321, which can contact and trigger the sensor 31. Furthermore, the elastic member 6 is arranged between the first triggering member 32 and the second triggering member 33. Specifically, the side of the first triggering member 32 facing the second triggering member 33 is provided with a first positioning hole 322. The side of the second triggering member 33 facing the first triggering member 32 is provided with a second positioning hole 331. One end of the elastic member 6 is placed in the first positioning hole 322 and elastically presses against the first triggering member 32. The other end of the elastic member 6 is placed in the second positioning hole 331 and elastically presses against the second triggering member 33.

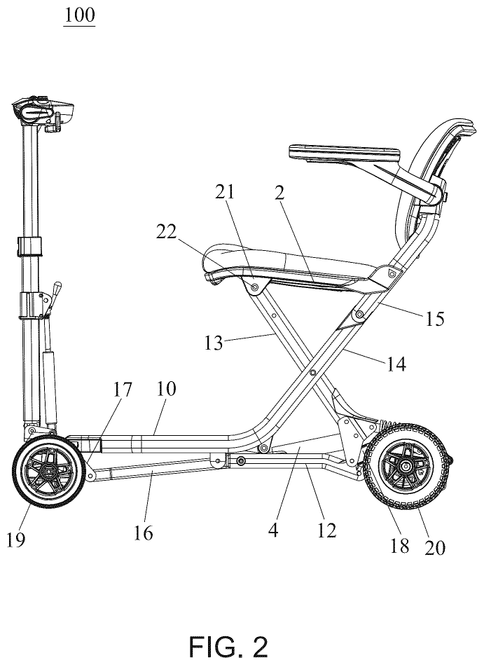

As shown in FIGS. 2 and 3, the vehicle frame 1 includes a front frame rod 11, a rear frame rod 12, a first support rod 13, a second support rod 14, a third support rod 15, a pull rod 16, a front wheel bracket 17, a rear wheel bracket 18, a front wheel 19, and a rear wheel 20. The rear end of the front frame rod 11 is pivotally connected to the front end of the rear frame rod 12. The front end of the front frame rod 11 is pivotally connected to the front wheel bracket 17. The front wheel 19 is mounted on the front wheel bracket 17. The rear end of the rear frame rod 12 is pivotally connected to the rear wheel bracket 18. The rear wheel 20 is mounted on the rear wheel bracket 18. The lower end of the first support rod 13 is connected to the rear wheel bracket 18. The second support rod 14 and the first support rod 13 are arranged in a crossed manner and pivotally connected to each other at middle parts thereof. The lower end of the second support rod 14 is pivotally connected to the rear end of the front frame rod 11. One of the end surface of the rear end of the front frame rod 11 and the end surface of the lower end of the second support rod 14 is provided with an engagement protrusion 111, and the other is provided with an engagement recess 141. The engagement protrusion 111 and the engagement recess 141 engage with each other when the frame is unfolded to lock the vehicle frame 1. The upper end of the second support rod 14 is pivotally connected to the lower end of the third support rod 15. The upper end of the third support rod 15 is pivotally connected to the rear end of the seat base 2. The slot 1a is provided at the upper end of the first support rod 13. The front end of the pull rod 16 is pivotally connected to the front wheel bracket 17, and the rear end of the pull rod 16 is pivotally connected to the rear frame rod 12.

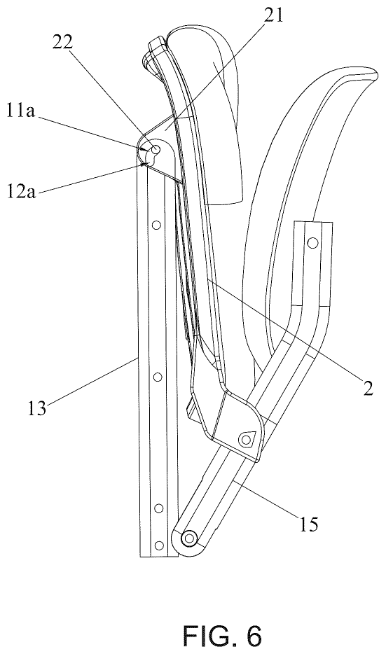

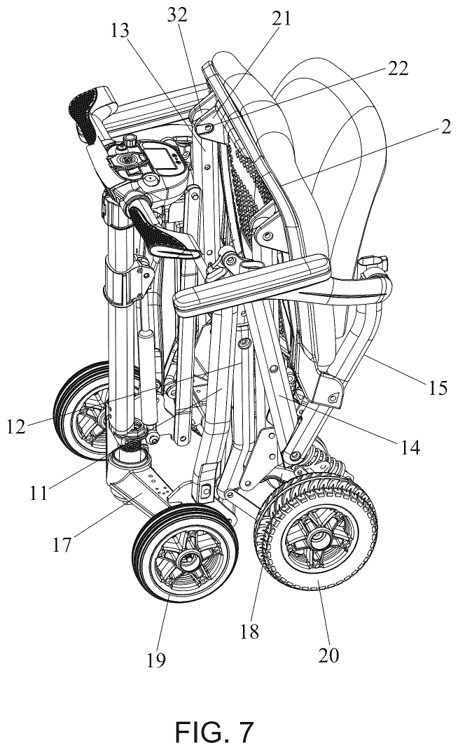

Referring to FIGS. 2, 6, and 7, the working principle of the folding vehicle 100 of the present invention is described in detail as follows.

When the folding vehicle 100 is fully unfolded and bears no load, the sliding shaft 22 is located at the uppermost end of the first slot 11a. At this time, the first triggering member 32 is away from the sensor 31, and the sensor 31 is in a trigger released state. The signal between the controller 5 and the drive device 4 is connected. The user can press the control switch to send a signal to the controller 5, causing the controller 5 to control the drive device 4 to start, and the drive device 4 can then drive the vehicle frame 1 to unfold or fold.

When the folding vehicle 100 is fully unfolded and loaded with a user, the seat base 2 bears a load. At this time, the seat base 2 overcomes the elastic force of the elastic member 6 and moves downward. The sliding shaft 22 slides from the first slot 11a to the lower end of the second slot 12a. Simultaneously, the sliding shaft 22 pushes the first triggering member 32 to move, causing the first triggering member 32 to slide along the extending direction of the first support rod 13 closer to the sensor 31, finally contacting the sensor 31 and thereby triggering it. The sensor 31 sends a signal to the controller 5. Upon receiving the signal, the controller 5 interrupts the signal connecting it to the drive device 4, or interrupts the signal connecting the controller 5 to the control switch. Thus, the control switch is failed to activate the drive device 4 via the controller 5. At this time, the vehicle frame 1 will not accidentally folded by the drive device 4, thereby greatly improving safety. When the user gets off the vehicle, the seat base 2 is under no load. The elastic member 6, under the elastic force, pushes the seat base 2 to reset, moving it away from the vehicle frame 1. The seat base 2 then drives the first triggering member 32 away from the sensor 31, releasing the triggered state of the sensor 31. Therefore, the controller 5 can restore the signal connecting to the drive device 4, or restore the signal connecting to the control switch, such that the controller 5 can then again control the drive device 4 to start folding the vehicle frame 1.

Compared to the prior art, the seat base 2 of the present invention is movably arranged on the vehicle frame 1, and the sensing device 3 electrically connected to the controller 5 is arranged between the seat base 2 and the vehicle frame 1. Therefore, when a user sits on the seat base 2, the seat base 2 moves relative to the vehicle frame 1 to drive and trigger the sensing device 3, thus the triggered signal is then transmitted to the controller 5, which controls the drive device 4 to stop operating. By this token, the folding signal of the folding vehicle 100 can be automatically interrupted by the sensing device 3, which prevents the vehicle with a user loaded thereon from accidentally folding due to misuse of the control switch, thereby avoiding accidental harm to the user caused by unexpected folding. The interruption is automatically triggered by the weight of the user sitting thereon, without requiring manual intervention, thereby enabling automatic control and effectively improving the safety of the folding vehicle 100.

The above descriptions are merely preferred embodiments of the present invention and are not intended to limit the scope of the application. Any modifications, equivalent substitutions, or improvements made within the spirit and principles of the present invention should be included within the protection scope of the present invention.

1. A folding vehicle capable of automatically interrupting a folding signal, comprising a vehicle frame, a seat base, a sensing device, a drive device, and a controller; wherein the seat base is arranged on the vehicle frame and has one end movably connected to the vehicle frame; the drive device is arranged on the vehicle frame and electrically connected to the controller to drive the vehicle frame to unfold or fold; the sensing device is arranged between one end of the seat base and the vehicle frame and electrically connected to the controller; when bearing a load, the seat base moves close to the vehicle frame and triggers the sensing device, and the controller interrupts a signal controlling an operation of the drive device.

2. The folding vehicle according to claim 1, wherein an elastic member is arranged between the vehicle frame and the seat base, and the elastic member provides an elastic force to move the seat base away from the vehicle frame, thereby releasing a triggered state of the sensing device.

3. The folding vehicle according to claim 1, wherein one end of the vehicle frame is pivotally connected to a rear end of the seat base, and another end of the vehicle frame is provided with a slot; a front end of the seat base is slidably arranged in the slot via a sliding shaft, when the seat base bears a load, the sliding shaft slides from one end of the slot toward the other end in a direction closer to the vehicle frame.

4. The folding vehicle according to claim 3, wherein the sensing device comprises a sensor and a first triggering member, the sensor is arranged on the vehicle frame and electrically connected to the controller, the first triggering member is connected to the front end of the seat base to move closer to the sensor and trigger the sensor as the seat base moves.

5. The folding vehicle according to claim 4, wherein the sensor is fixed inside a first support rod of the vehicle frame, the first triggering member is slidably arranged on the first support rod of the vehicle frame, the first triggering member is provided with an elongated hole, and the sliding shaft slidably passes through the elongated hole.

6. The folding vehicle according to claim wherein the sensing device further comprises a second triggering member fixed inside the first support rod of the vehicle frame, and the sensor is fixed on the second triggering member.

7. The folding vehicle according to claim 3, wherein the vehicle frame comprises a first support rod, a second support rod, and a third support rod; the first support rod and the second support rod are arranged in a crossed manner and pivotally connected to each other at middle parts thereof; an upper end of the second support rod is pivotally connected to a lower end of the third support rod; an upper end of the third support rod is pivotally connected to the rear end of the seat base; and the slot is provided at an upper end of the first support rod.

8. The folding vehicle according to claim 3, wherein the slot has an arc-shaped structure.

9. The folding vehicle according to claim 3, wherein the slot has a bent structure.

10. The folding vehicle according to claim 3, wherein the slot comprises a first slot and a second slot, the first slot extends from an upper end toward a front lower direction of the folding vehicle and communicates with one end of the second slot, and the second slot extends toward a rear lower direction of the folding vehicle.

11. The folding vehicle according to claim 5, wherein the sensing device further comprises a second triggering member fixed inside the first support rod of the vehicle frame, and the sensor is fixed on the second triggering member.
